(19) United States
(12) Patent Application Publication
(10) Pub. No.: US 2009/0171695 A1
(43) Pub. Date: Jul. 2, 2009

(54) SYSTEM AND METHOD FOR INTERACTIVE MANAGEMENT OF PATIENT CARE

(75) Inventors: KOFI B. Cobbinah, Houston, TX (US); Marzyeh Ghassemi, Hillsboro, OR (US)

Correspondence Address: INTEL CORPORATION;c/o CPA Global, P.O. BOX 52050, MINNEAPOLIS, MN, 55402, US

(73) Assignee: INTEL CORPORATION

(21) Appl. No.: 11/967,601

(22) Filed: Dec. 31, 2007

(51) Int. Cl. G06Q 10/00

(52) U.S. Cl. 705/3

(57) ABSTRACT

A system for interactive patient care management that includes a database of patient records and a second database of skilled personnel tasks that can be related so as enable a display of relevant patient care tasks and relevant patient record data. The result is the enablement of patient care delivery that takes advantage of the presentation of approved patient protocols and facility resource information in a hierarchical display form to reduce caregiver errors.

### BACKGROUND OF THE INVENTION

1. Field of the Invention

Embodiments of the present invention relate generally to the automation of patient care task guidance through the use of computer database systems enabling the rapid consideration of patient health records and resources necessary to administer defined health care to a particular patient or group of patients.

2. Background

The world of recordkeeping, of any type, is on a steady pace to become fully implemented on electronic platforms for the entry, storage, organization, manipulation, and retrieval for a seemingly endless diversity of transactions involving commerce, government and, in the case of this disclosure, electronic medical records or EMR. EMR has been in the implementation stage for over a decade, and has many aspects relating to the administration of the healthcare, economic transactions associated with the care, and, more recently, significant patient privacy concerns, both practical and government imposed.

One important function of electronic medial records (EMR) is the data set or library of data used to feed into the system. The development of EMR libraries promote a systematic storage and retrieval of a wide variety of records related to the management of health care and, more broadly, the records to run a medical facility where the patient is a customer of the care given by the facility. EMR libraries of data focus, however, on the storage, management and retrieval of the record data for viewing. It is appreciated that such systems would reduce errors, but not errors that may be introduced by a user of the system improperly interpreting the recorded information that is presented to them.

It is recognized there are many past and present initiatives in the medical industry and in government, both in the United States and abroad, to promote the creation and use of EMR. Recently, President George W. Bush made mention of the need for such technological advances when in his State of the Union Address, Jan. 20, 2004, he said, “By computerizing health records, we can avoid dangerous medical mistakes, reduce costs, and improve care.” President Bush's initiative has two stated goals: “Within the next 10 years, electronic health records will ensure that complete health care information is available for most Americans at the time and place of care, no matter where it originates. Participation by patients will be voluntary. These electronic health records will be designed to share information privately and securely among and between health care providers when authorized by the patient.” With such high level recognition of the issues and government commitment to evolution, the capabilities of our society to record, retain and exchange EMR will occur and all the potential of EMR utilization will be realized.

Many previous implementations or utilizations of EMR, include the implementation of the data in a central server, sharing of information between entities such as the care giving facility and insurers and government agencies administering health benefits. There are also implementations for the caregivers, including physicians, to set up orders that are distributed to pharmacies, health care appliance providers and the like for the benefit of the patient. There is also movement towards the integration of the devices used to monitor various conditions being integrated on a system level as well. What is needed, however, is a tool that properly integrates EMR in a way that is conducive to meeting the goals of care accuracy, cost-effectiveness, and speed all concurrently.

In view of the forgoing, there is a need for efficient utilization of electronic medical records in a manner that will promote efficiency in the administration of health care and enable a reduction in errors that might represent a risk to the patient. Each time care administered is there is also a need to understand the procedures necessary to be presently performed, along with the resources deemed necessary to complete the procedures. The resources can consist of consumables necessary to perform various procedures, health care appliances, or something as simple as a hypo-allergenic disinfecting mop to prepare a patient's room.

Current electronic medical records and clinical information systems also provide nurses with information about current orders for each patient. However, these systems do not provide dynamic information on the patient's current status, task list, medical history, etc., that can be conveniently used to monitor all aggregated data and provide an integrated and interactive display for ease of use, on even the most mundane of tasks.

### BRIEF DESCRIPTION OF THE DRAWINGS

The disclosed invention, together with further advantages thereof, may best be understood by reference to the following description taken in conjunction with the accompanying drawings.

FIG. 1 is an overview of the system aspects of the disclosed method of interactive patient care management.

FIG. 2 gives detail and example to one the display options for the system and method of interactive patient care disclosed herein.

FIG. 3 is an example of two types of display options for the hierarchical presentation of patients and associated patient care tasks.

### DETAILED DESCRIPTION

Often conditions are missed or diagnosed incorrectly as a result of a lack of information. A system is disclosed for the interactive display of tasks and resources necessary to administer all aspects of patient care. The disclosed embodiments include provisions for display arrangements based on hierarchies of urgency, specific user, current needs and many more aspects that may require the organization of the information necessary to understand what has been administered to any one or more patients and prioritizes incomplete tasks and information in the patient care process flow. Since patient care is such a broad concept and is administered by so many personnel at various skill levels, the disclosure provided herein is correspondingly broad so as to fully appreciate the invention. In the following description, numerous specific details are set forth in order to provide a thorough understanding of the present invention. It will be apparent, however, to one skilled in the art that the present invention may be practiced without some or all of these specific details. In other instances, well known steps and technologies have not been described in specific detail in order not to unnecessarily obscure the present invention.

As previously introduced, EMR systems are undergoing a transforming evolution towards digitization and all the utility associated with that transformation. Because the transformation is ongoing, the current process support for patient care uses a mix of paper-based and digital information. As a consequence, the process flow and the proper caregiver procedure may be difficult to determine in an expedient manner. Priority and process flow information are currently controlled by the memory and communication of people, whose memory and communication skills can vary greatly depending on the stress and situation they face. This mental sorting out of things can lead to errors in a field where such errors can be detrimental to the health of the patient, even to more serious consequences like death. The system disclosed here uses available EMR and data related to skilled personnel protocols to free the caregiver to concentrate on the procedure or process they must perform and enable the proper reporting of task completion. This frees the information for all caregivers to deal with as their abilities and time dictates.

Currently most care providing areas use a mix of digital and paper-based systems to record patient needs and health “passport” information such as orders, assessments, medication administration, lab results, diagnostics, and clinical notes. There may be a specific caregiver that provides the priority and process flow information for each patient's needs to all subsequent caregivers. This is both inefficient and impedes the flow of caregiving resources/individuals to where they might be most effective. Additionally, if many caregivers are working together, a solid list of patient care priorities will help the caregivers establish their own priorities and workflow most efficiently.

Embodiments of the invention provide systems and methods that enable interactive management of patient care information in a hospital, healthcare facility, or in a home, at the patient's side. The disclosed system would be especially useful in dynamic, fast-paced care environments, (e.g. A nurse in a hospital), but could also be valuable in more relaxed patient health care settings. As such, the system should not be considered to be limited to any particular setting disclosed herein. This system and method could encompass the time, location, medication, tests, and process flow of each patient that the caregiver needs to tend to. Each patient's information “passport” of information necessary to administer to their care is tied to their medical needs. Those needs are organized into their level of urgency, and within each task, the progress towards completion can be identified. In this way the caregiver can immediately assess the need of each patient and insert him/herself into the process flow of caregiving to provide the most efficient maximization of their time. This is especially valuable in a hectic setting where several caregivers may have interacted with the patient and provided some level of care.

### Health Passport

Each patient can be identified by their “health passport”. A health passport is a digital information data image: at any one instance of time it is a snapshot of an individual's personal health record, tied to key background information about that person and their relevant treatment history. This passport is a huge improvement on the traditional method of patient health information storage which typically consists of a large group of papers with various bits of the information any particular caregiver might need. These paper based methods result in records that are written in an illegible manner, or put together in an unorganized fashion, depending on the previous person who accessed or wrote on the file. As the previously disclosed EMR initiatives progress, this information will move from the current mix of paper based data and to be fully captured as electronic data. For the purposes of this disclosure, the health passport is an organized set of electronic data whose structure is chosen to facilitate the logical display and interaction embodiments disclosed herein. Thus, any number of data structure choices can be made and still be within the scope of the system contemplated here.

The health passport includes all relevant medical information, and other information that would otherwise be traditionally stored on a patient flipchart. For example, the room number, date of admittance, principle doctor, medication allergies, current healthcare need and exasperating conditions. The health passport also enables capability to compile historical patient data that was part of their health or treatment records. This would be particularly important when dealing with a patient that has multiple conditions affecting their health. The health passport catalogues those conditions in a defined data structure and serves as a data source for the system and methods of display disclosed throughout this specification. Such a ready source of data enables a direct sanity check and administratively imposed double checks prior to the administering of care.

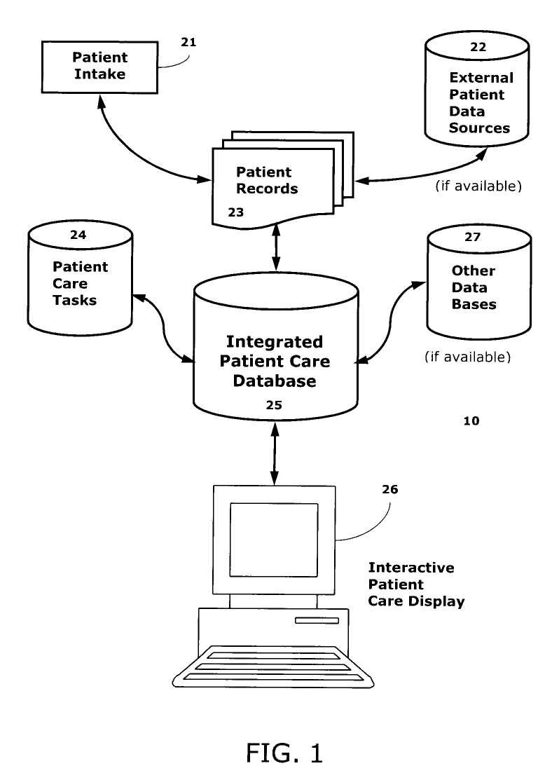

In the context of the system disclosed here, the health passport is assembled from data as shown in FIG. 1. At patient admittance to a hospital or more generally at patient intake 21, a patient record 23 is created. If the patient was previously served by the facility, the records from previous treatment are retrieved and added to the current record. This current record can then be augmented by best available information from third parties 22 in the industry in an attempt to bring the patient records 23 as up to date possible. Since, as previously introduced, EMR is evolving, the ability to garner the patient's past history is expected to improve and this third party information exchange process will become more robust. At this point of the admittance process, there is a functional patient record 23 developed for the patient in the caregiver's integrated patient care database 25. In the system illustrated in FIG. 1, the communication with external patient data sources is shown as bi-directional in recognition of the fact that the caregiver's system becomes a third party data source for some other caregiver's integrated system. Consequently, it is expected that this aspect of the contemplated invention will improve in capability with time. However, as noted in several instances in this disclosure, the system can be designed to work some minimum set of information compiled at patient intake. This minimum may or may not include history information communicated by the patient or other source accompanying the patient as part of patient intake. This exchange and update method of communication of patient medical data may have to pass through many privacy portals, but with the exchange of such third party or external information in inclusion in the patient record, patient care is enhanced by the integration into the system currently responsible for the patient's care.

When a patient is admitted to the health care setting, their Health Passport is activated. The passport can be structured in the system to enable a user to bring up an overview screen with the patient's name, an associated picture useful for positive patient ID, a list of their last few health conditions, a list of their past few major treatments, medical allergies, and exasperating conditions. Because, as previously disclosed, the patient record 23 may be limited to that which the patient could recite upon admittance, the patient records 23 present in the integrated patient care database 25 are designed to be, at a minimum, that which is necessary to support the medical procedures and protocols coming from the patient care task data set 24. Thus, the implementation of the system developed in accordance with this disclosure would need, from a database structure perspective, to consider that the system needs to work with some established minimum patient record information. This minimum could be, for example, the patient name, sex, age, known allergies, known history and other minimal information the patient can recall upon admittance. Also, recognizing that the patient may not be conscious upon admittance, having been transported in an emergency vehicle, for example, the data structure should be chosen to interact with John or Jane Doe information that the admitting personnel can glean from observation or other investigation of artifacts on the patient's person at the time of admittance. Thus, the data structure for the integrated patient care data base 25 is configured to operate with a record size ranging from the minimal information necessary to identify the patient up to a robust record with the entire history of a lifetime of medical treatment in a variety of settings. This robust end of the range will be achieved when the EMR evolution has more time to run its course and connect the world of medical data.

Upon admission to the medical facility, admitting personnel could then enter the current health condition responsible for the patient's admission. This, intake adds data to the patient records 23 and once the record is present in the integrated patient care database 25 it can be logically related by in inference engine to communicate with relationships to the patient care tasks 24 to generate display of tasks, alarms and other caregiving guidance appropriate for the medical conditions noted. In one embodiment of the invention, the inference engine can be automatically related to patient care tasks as the associated conditions or combination of conditions and symptoms are entered by the various skilled caregivers interacting with the system. In another embodiment, the patient care tasks can be displayed 26 to a caregiver as selectable options for treatment and a treatment plan selected by the caregiver and set up for implementation at integrated patient care display 26 stations accessible by skilled personnel throughout the facility. Such an implementation would be well suited for a large hospital or medical facility, but it should be appreciated that it would also work in smaller facilities where there are only a few integrated patient care display stations 26 or as few as one for use by, for example, the sole caregiver using the system. Thus, it can be appreciated that the integrated patient display function 26 shown in FIG. 1 represents one or more units configured in a stand-alone o networked system implementation.

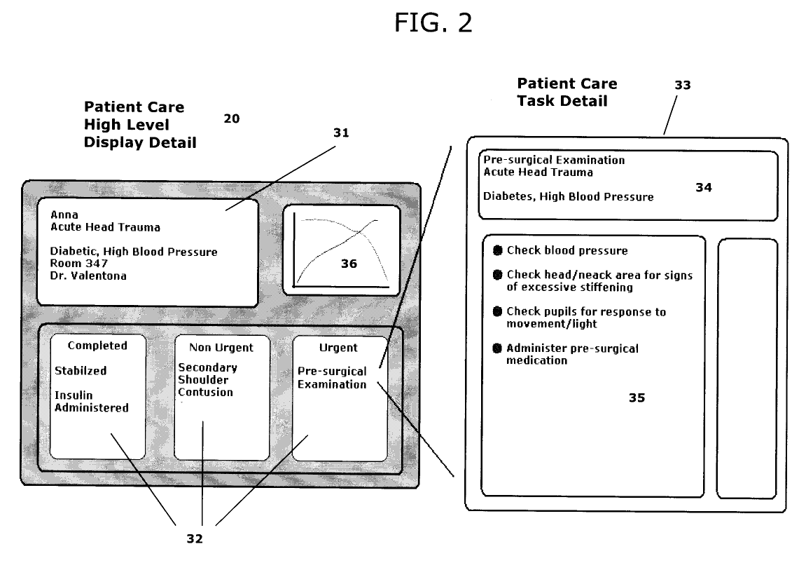

For every health care condition, there is a matrix of tasks needed to complete the patient's current care needs. As a matter of example, these tasks could include administering medication, intubation, inserting an IV, monitoring of one or more symptoms, etc. The patient care tasks are stored in the patient care task database and logically related to conditions that may be noted and generated as part of the patient record 23 developed in the integrated patient care database 25. As illustrated in FIG. 2, the patient care tasks 33 can have pre-requisite care tasks 34 or as subordinate task details 35 the display of which can be configured in any number of ways in addition to that shown in FIG. 2 to achieve the notification to the caregiver desired by the system designer. They can also be enhanced through the use of icons, flashing or animated alerts, or overlays driven by, for example, the amount of time since the last alert acknowledgement by the caregiver. The objective of all these embodiments is the relating of patient record information 23 to the patient care tasks 24 in an inference engine that drives display templates designed to provide critical information when needed, prompt the administration of error free care and enable the caregiver user with a display of the details necessary to complete all tasks.

### Patient Care Priorities

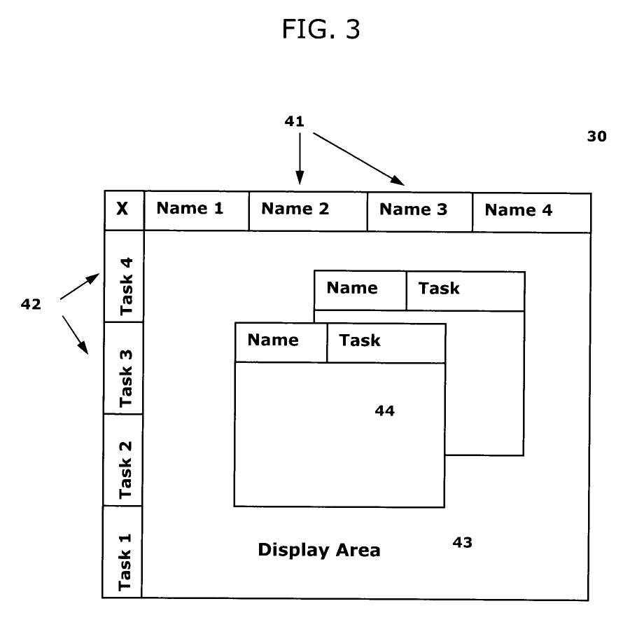

In order to prioritize the information for a user or caregiver, each patient need can be sorted into a high level display detail 20 as shown in FIG. 2 into a separate column according to its priority in the patient's care: Completed 32, Urgent 32, and Non-Urgent 32. However, as it can be appreciated, this hierarchical prioritization can be achieved in any number of ways using different arrangements in the display such as the columnar format 32 shown in FIG. 2 or the tabbed format 42 shown in FIG. 3, or alternatively the overlay format 44 also shown in FIG. 3. Beyond that tiled formats, radial formats, iconic formats, or any other display annotation deemed to be best suited to the platform on which the system is implemented, is appropriate. The functional aspect of this particular embodiment is a provision enabling the caregiver user of the system by providing a selection is presented and enabled with some means of making that selection to get further patient care task detail 33 as shown in FIG. 2. Such selectable tabs or display objects will necessarily be associated with commands that facilitate the display of the patient care tasks detail 33.

Any task in a certain treatment suite will have its priority level set by a head caregiver beforehand, but can be altered by appropriately authorized personnel at a later point should the need arise. For example, before this system is used in a hospital, a critical care protocol development team would have developed a logical structure of treatment priorities to be completed when a head trauma case is admitted. As shown in FIG. 2 this may consist of one or many large tasks 32 (e.g. “Pre Surgical Examination”, etc.) with several subtasks 33 within each general task 32. This breakdown of detailed medical treatment procedures can be assembled into a database of procedures and stored for recursive use in a database 24 linked to the system as shown in FIG. 1. The patient care database 24 is a data source for the integrated data set 25 that drives the system on a day to day basis.

Once a task is completed, the inference engine moves it, for example, from the Urgent or Non-Urgent lists 32 to the Completed tasks list 32, which will be kept on-screen in a separate column to ensure that the caregiver can review the patient's care flow. This hierarchical movement of tasks is given as one embodiment of the type of prioritization or categorization that could be done in the system disclosed here. Other forms of indexing of information could be performed and used and still meet the objectives of this system. In another embodiment, the skilled personnel using the system could be caregivers whose function it is to prepare or maintain a room for a patient. For these personnel, the important information would be information about the type and frequency of maintenance required to control their type of infectious disease. For example, if the control recommendations include things like: i) Private room, ii) Contact precautions (gown, mask, gloves, antibacterial soap for hand washing), iii) Minimize the number of persons with access to colonized and infected patients, etc. The skilled personnel preparing the room would provision the room with the assets and consumables necessary to enable the completion by other skilled caregiver tasks generated by the inference engine for that particular patient. The completion of the room preparation activities would be noted in the associated patient record and that information would be retrievable by subsequent personnel accessing the system to perform their tasks.

### Process Flow, Interrupts and Authentication

For each task that needs to be completed in a patient's care flow, there is a process flow to successful completion. Most tasks can be made into a discrete series of steps. By breaking down each task into a discrete series of steps, you allow for its efficient completion in a resource scarce environment. For example, a patient may need to answer questions, have a blood pressure taken, and then be provided with medication in a routine pre-surgical checkup. The inference engine in the integrated patient care database 25 would make available for presentation to skilled caregiver personnel the currently available steps to be performed. In one embodiment, the tasks are presented in a specific order because it is required by the protocol to ensure patient safety and correct implementation. When the specific order implementation is required, the system provides for overlays and warning prompts in both visual display form and audio alerts to ensure the caregiver skilled personnel are alerted to the need for in order implementation. In another embodiment of the invention, the steps can be performed out of order and this approach may or may not be annotated to the caregiver user as an option. In yet another embodiment, the concept of floating steps that must be continuously performed along with other steps being performed, such as check blood pressure or temperature every fifteen minutes, is presented to the caregiver user visual and/or audible form to enable the completion of the step.

In the dynamic world of caregiving, there may be a sudden need in another area for the nurse that is providing care. An embodiment of the system contemplates a process flow that allows for the easy insertion/removal of specific caregiving resources without prolonged explanation of the progress made. This display of recently performed tasks or task history, current patient status, for example, in the form of vitals, next steps to be performed, and resources available to perform them is an important improvement offered by the disclosed system. It is this manipulation of data into a snapshot of current patient status and near-term needs that enables the caregiver recently inserted into the patient care process flow to be immediately effective. This effectiveness could be necessitated by the overwhelming demand, as in the case of a disaster response or demand placed on the caregiver by short staffing situations that commonly occur when caregiver resources are stretched thin by emergent work pile-ups that occur despite the best of staffing plans. Additionally, a caregiver that returns to the patient would need to access both tasks to be performed and task history to reorient themselves to complete actions they only meant to leave momentarily, but the flow of which may have been modified by tasks completed by a caregiver intervening in their care of that patient.

The versatility of the patient snapshot display of the integrated patient care display is also useful for long-term patient caregiving where there is a regular, often lengthy, list of tasks to be accomplished on a rotating basis and the caregiver that is assigned to that particular timeslot, floor or other care unit may not have dealt with the patient's needs before. It can be appreciated that the snapshot or summary could be any number of combinations of patient record data or patient care tasks that are necessary to make the current caregiver effective in their present task. The disclosure contains some examples, but many more combinations of patient record fields and patient care tasks could be used by the inference engine in the integrated patient care database 25 to make an almost limitless combination of summary displays or snapshots and be within the contemplated scope of the system disclosed herein.

The system contemplates, although it is not shown in the figures, that the integrated patient care display 26 and the integrated patient care database 25 would have provisions for user authentication. Each skilled caregiver in the facility implementing the disclosed system would have a user ID in the various databases contemplated to support the integrated system. The user ID would give them either access to the data they need or in the case of one embodiment, rearrange the patient care displays to be consistent with the particulars of their authorized level of care to the patient and the current needs of the patient. That is to say that a skilled nurse, for example, in the intensive care unit or cardiac care unit, might have access to procedures and protocols specific to there area of care, their educational level or skill level based on a logic structure set by department management personnel or committees in the facility responsible to give such authorizations. In addition to using user authentication for the purposes of relating to the proper personnel skill levels, user ID authentication methods may be necessary to determine access levels to patient health history as part of this system. Patient record security will be necessary to meet facility policies and procedures, as well as government regulations regarding patient health record privacy. This user authentication can be part of the schema previously proposed or a completely separate process to ensure the appropriate privacy of patient records.

In the case of user specific displays, the functionality previously described in the general sense, would be further tailored to be specific to that skilled personnel currently using the system. Because it is one objective of the system that it be enable users to share the display terminals or output, provisions for the restoration of the display and care directives to that of a previous user are also contemplated. This restored display would need to consider those tasks that may have been performed by others in the time period interval since they last accessed the system. Thus, the integrated patient care display 26 would not necessarily, be restored to exactly where they left off, but would consider what had been done since. Since, however, it is contemplated that the system would have an audit trail of all work performed with respect to any one patient, persons performing a review or quality assurance function on the system would be able to see all points of care administration and acknowledgement of task completion. In this manner, the system considers not only the administration of patient care, but also functions necessary to audit that care as well.

The user authentication method chosen can be anything from some sort of user ID and password combination, or swipeable ID badges carried on the person combined with passwords or sophisticated wireless authentication that enables hands free access on the part of authorized users. The badges could have barcodes, RFID or other radio chips that transmit ID and be combined with other authentication methods, such as password, voice recognition, or other biometrics to create a security protocol to identify the user and grant access as appropriate. There are various combinations of hardware and software implementations for the user ID authentication that could be performed and still support the contemplated system. It is easily envisioned that some sort of hands free system might be very useful in a caregiving facility setting where use of other systems may not be consistent with the need to maintain sterile or infection free boundaries. Because some of the methods useful to the system implementation may include wireless devices and there is a need for privacy in the records of the various databases making up the system 22-25, 27, any wireless embodiments would necessarily include appropriate encryption in the user ID authentication and other data transactions to ensure the data is secure. In sum, there are many hardware and software implementation choices for user ID authentication that would be within the scope of the system and methods disclosed herein.

### DETAILED DESCRIPTION OF THE FIGURES

FIG. 1 is an overview of the system aspects of the disclosed method of interactive patient care management. The system of integrated patient care 10 is shown. The process of patient intake 21 is shown and is generally common to all embodiments contemplated, as the patient must enter into the process flow to originate a need for the integrated management of patient care 10. The manner and method of patient intake can take many forms, but as previously discussed, some minimum level of information such as a patient ID, gender and other artifacts must be established at patient intake to create a patient record and to provide a logical decision point for the inference engine to drive the integrated patient care display 26.

FIG. 1 also illustrates there could be a plurality of patient records 23, as a facility handling many patients needs over the course of a day, week or month would need such a capability. It is not necessary to have many records, but the database schema and proposed storage strategies for the various embodiments of the system contemplate that personnel responsible for any IT system architecture would be mindful of the need for large amounts of storage space, as well as, archival needs for the storage of EMR, patient care tasks and other data that may be aggregated to implement the integrated and interactive patient care system disclosed herein.

Assuming there to be interface with external sources for patient data, the system contemplates interface with these sources 22. As previously disclosed, the communication with these data sources is bidirectional as the system implement in accordance with this disclosure could be interfaced to provide updated patient to a plurality of external data sources reflecting the care given the patient in the facility using the interactive patient care management system disclosed herein. FIG. 1 also shows the connection to the external patient data sources as optionally available. This optional availability to the system recognizes that once the minimum required patient record is met, the system can proceed to be fully functional in its goal of providing interactive patient care management, regardless of the level of access to patient data sources external to the system.

The patient records are stored, manipulated and managed in the integrated patient care database 25. The database can be implemented on any number of data platforms so long as the data is made available on the interactive patient care display. As such, the disclosed system contemplates a range of storage options from a large server all the way to a flash media with the capacity to store and manage the patient records contemplated for the system. These data management resources can be connected to other aspects of the system using wired or wireless networks, the connections can be of a ad hoc or permanent nature, so long as the connections exist long enough to conduct the data transactions necessary to drive the display or the inference engine implemented to match patients, skilled caregivers, and resources using the disclosed system.

The integrated patient care database 25 us also serviced by an inference engine that considers the patient record data, all other external sources relevant to the patient at hand and the patient care task data and integrates it all to generate the appropriate artifacts to be displayed at the present time. Included in the data available to the inference engine is the data from the facility user ID data set, skilled personnel files, facility asset and consumables resource database and any other databases set up to communicate the resources necessary to complete one or more relevant patient care tasks. The inference engine will generate data for display comprising the relevant information according to a prescribed rules set that may be prioritized and selectable as previously disclosed for a more detailed inquiry by the skilled caregiver currently accessing the system. There are many ways that these rules could be implemented in a software stack sitting on the database, but the final determination of these details is not necessary to fully appreciate the embodiments of the invention as disclosed herein.

In one embodiment, the integrated patient care database is serviced by a patient care task database 24. It is this database that provides the process flows, pre-requisites, procedures, protocols and other data necessary to assemble a complete task or set of tasks for presentation to the user caregiver. These can be aggregated in one patient care database or a set of logically related databases, as deemed efficient by the system designers. As previously disclosed, the patient care task database 24 is a set of reviewed and authorized protocols to be administered to patients in the facility implementing this system. Because the patient care task database is a central repository and it is updated regularly, the facility management team can be confident that current information is being used for all patients admitted and served by the facility. Additionally, another embodiment of the invention includes provisions for the immediate update of protocols for conditions such as infectious outbreaks, disaster response or other fast moving events. An additional embodiment contemplates that lessons learned from a preventable error review or critical quality review would be input to the patient care task database 24 and, thus, be immediately available to the inference engine in the integrated patient care database 25. The patient care task database 24 serves as one of the data resources for the inference engine to create the displayed patient care tasks, priority and other display artifacts.

The patient care task database 25 enables the relationship of the patient care tasks to personnel in the facility qualified to perform such tasks. This qualification data can reside in the patient care task database 24 or in one of the other databases 27 shown as logically related to the integrated patient care database 25. The skilled care giver qualifications will likely be based on personnel position descriptions, but could also be indexed by specialty training caregivers have received as part of in-service education programs administered at the health care facility that are tailored either to specific procedures and protocols at that facility or more general procedures and protocols approved in the industry. The trainings could be those available at industry groups or conducted at any of a variety of facilities with the credentials to conduct such training. The functional aspect of the qualifications is that they are recognized and tracked by the facility using the interactive patient care system 10. In one embodiment, these qualifications could are made available to the inference engine and, using the caregiver ID authentication methods disclosed herein, the interactive patient care display 26 is configured by the system to display tasks specific to the caregiver currently accessing the system. In yet another embodiment, the qualifications are grouped in any number of appropriate groups and related to the care units to enable access by groups of users similarly qualified. The tracking of these qualifications further enables functionality, which in one system embodiment, displays and or notifies a user of lapsed qualifications to perform a specific procedure. Thus, the system designer is free to index in a grouping and logical manner that best supports the business, security and efficiency objectives of the facility using the system.

FIG. 1 also shows a link to “other” data bases 27. This link represents transactions of the integrated patient care database with other data sets as necessary to enable the consideration of facility asset management and coordination, non-skilled caregiving tasks, facility billing administration or other data sets not disclosed here, but which have data that is desired to be coordinated with patient care tasks and displayed on the interactive patient care display. An example of this type of data is the coordination of the location of various stand-alone medical monitoring devices such as respiratory therapy equipment, cardiac monitoring devices, medication dose monitoring devices and the like. These assets can be costly and, depending on the patient load of the facility, difficult to resource to the patients. Through the use of the link to a database of their current locations, personnel needing a device to be delivered locally can use the interactive display, note the need for a device and get information on where the nearest available device is located. Thus, as mentioned previously, scarce resources are efficiently used with the system. Additionally, in another embodiment, the educational records and skill level designations of care giving personnel are one of the additional databases 27, not specifically enumerated in the figures, that could be logically related as a separate database and further associated with either or both of the patient care task database 24 or the integrated patient care database 25 as necessary, to effect functionality that would consider the skill level of persons performing each patient care task. These examples of other databases capable of providing data to the integrated care database are not exhaustive. Other databases with data pertinent to the goal of patient care delivery could be linked and the information made available on the interactive patient care display 26 to the benefit of patient care.

It is noted that the previous discussion mentions different data bases to be used in the implementation of the disclosed invention. Additionally, the figures disclose the database functionality. This discussion of different databases is in no way limiting the logical division of the databases. It is recognized that many different divisions could be chosen and the objectives of the various embodiments of the invention would be achieved. Thus these divisions should be considered as a way of example and the system designer should chose the best implementation of databases, data sets and communication of data between the data sets and the interactive patient care display 26 so as to keep to the concept of the disclosed system and be mindful of data security, privacy and practical concerns not addressed in this disclosure.

FIG. 1 also shows the interactive patient care display 26. This display supports interaction with skilled caregiver personnel responsible for the direct and indirect administration of care to the patient. Although the chosen illustration looks like a conventional computer workstation, any number of embodiments from what is currently known as a PDA or other hand-held wireless implementation up to and including a computer workstation or terminal. The platform chosen for the interactive display 26 need only support that level of interaction contemplated for the setting into which it is to be implemented. If, for example, it is a caregiver that must cover a number of patients and the particular display for this skilled person need only alarm to give notification to look at a larger embodiment of the interactive display in the patient's locale or at a central nurse's station, for example, then something a small form factor, such as a current generation personal data assistant (PDA) would suffice. The PDA or small form factor device could also serve as a proxy device for a larger workstation, be connected wirelessly to the directly to the network in the facility or to the nearby workstation, be equipped to display a subset of the tasks or further abbreviated tasks of the complete list and prompt the skilled caregiver to consult a larger display 26 for more detail. If mobility is needed, but more functionality is required, then perhaps a larger form factor, with more display area, like a laptop or tablet notebook platform might be more suitable to enable the desired functionality. The system is not limited by the choice of the display platform, but the ability of the caregiver personnel to be properly alerted and interact may be limited and, thus, the notification and interaction needs will, perhaps, drive the choices made for the platform. Additional considerations in the choice of the platform may involve some of the hands free disclosure earlier and an embodiment contemplates audio interaction with the interactive patient care unit 26 and the caregiver receives and responds to information using his or her voice. In this manner, the device would “display” the information in an audible summary and the caregiver can acknowledge via a voice response. These examples are given to illustrate the range of options available for a system developed in accordance with this disclosure.

FIG. 1 shows transaction paths between the functional units making up the system. In all instances the transactions are shown as bi-directional to connote the interaction between the functional units and the allowance for each of the functional units to be a data provider or resource and the opposite transaction where the resource is updated from the patient record 23 or integrated patient care database 25. It is also further illustration of the contemplated flexibility in implementation that falls within the system contemplated and claimed herein.

FIG. 2 shows an exemplary detail of a patient care display task as shown on the interactive patient care display 26. The task is shown to a caregiver with an optional header record 31 of a brief amount of information, an optional hierarchy of the priority of a given task 32. Further breakdown detail 33 can be easily obtained and displayed on subsequent or tiled screen as shown in FIG. 2 and also in FIG. 3. This breakdown also has a header record and convenient reference 34 with the task detail provided in a second region of the display 35. This recursive inquiry to additional detailed screens can be accessed using controls, such as selectable objects, present on the higher level detail screen or provided externally on the interactive patient care display unit 26. The selectable objects on the display will have some means of highlight and selection of a menu or other presented item and an associated software task that enables the user to gain access to and display the desired detail. Because the detail may not be viewable on smaller form factor devices, the selectable objects may present that level of detail appropriate to the platform or, as previously disclosed, use a combination of the platforms to achieve the display to the caregiver personnel.

The first display shown in FIG. 2 can also be provided with additional regions 36, space permitting, with a data analyses area to allow caregivers to interact with and analyze data that may be relevant to the patient's care. These regions could be provided with zoom and reduce controls so that in smaller form factor platforms, the interactive data field can be made large enough for manipulation and then reduced in size to enable viewing of other tasks.

FIG. 2 also gives an example of the hierarchical display of information 32. Here the priorities of the task are shown and associated tasks given for each priority. Alternatively, if the care giver was responsible for multiple patients, the data from multiple patients could be displayed and upcoming or differing priority tasks distributed among the patients could be displayed in the manner shown in FIG. 2. FIG. 3 also shows other optional embodiments for the hierarchical display of tasks in the system contemplated in this disclosure. The distribution of names across the top of the display 41 and the tasks on the left side of the display 42 gives further examples of the embodiments supporting the distribution of care among a group of patients. In this embodiment, the display area 43 in FIG. 3 is reserved for the details of each task or patient that might be selected using this display. This type of configuration gives the care giver options to consider which equipment might become available, for example, in making the decision regarding which patient to next administer care. An additional option in FIG. 3 for such support multi-level display is the tiling 44 of the different patient care tasks or differing levels of detail on one task. This overlay approach, would allow for the caregiver user to move windows around, while still retaining the header information regarding which task is to be performed a corresponding patient. Additional options for the prioritization includes the use of colors in the displays to connote different hierarchical schemes or flashing alerts to draw the attention of the skilled caregiver to tasks needing attention or too long delinquent. The selection of any or all of these options in an implementation are left to the discretion of the system designer and likely driven by practical considerations of display options available on the platforms chosen for the system implementation.

The hierarchical schemes presented above can be modified depending on the caregiver user. In a hospital, for example, there is a great diversity in responsibility levels among the staff. Those directly responsible for the care may necessarily have their interactive patient care display 26 limited to the patients at hand in a respective care unit. A supervising or head nurse may have their unit configured by floor, unit, doctor, groups of caregiver staff, individual caregivers, or whatever logical division is necessary to enable the oversight functions are to be achieved by their position. These supervisory functions may allow this management function in the hospital to intervene before resources become scarce and take action to make staff resource movements or asset movements necessary to prevent a care crisis in some area of the facility. Alternatively, a doctor may want an interactive patient care display unit 26 configured to view his patients care and support his rounds to be performed. These alternative groupings of tasks and patients are alternate embodiments to those previously disclosed and within the contemplated architecture of the system disclosed here.

Although the disclosure to this point focuses on skilled positions and skilled care resources, it is within the scope of the contemplated invention that the integrated patient care database 25 would consider and interact with all aspects of a healthcare facility management as it relates to patient care. One example previously disclosed dealt with the preparation of the patient room. Additionally, the status of facility and asset maintenance could be considered when notifying the caregiving personnel of nearby resources and the proper status of their readiness to support the patient care tasks. Thus, if a caregiver decided to take a patient on a long walk for a change, they could decide to take the route were all the electric doors were in working condition and not be confronted with an unplanned obstacle. Thus, the other databases 27 shown in FIG. 1 could include such facility data.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A system for interactive patient care management comprising: a first electronic database of patient records, a second electronic database of skilled personnel care tasks, related by an inference engine capable of selecting patient records and patient care tasks from the first and second databases and integrating the selected data to enable the display to a skilled caregiver responsible for the care of a patient, of at least one aspect of a patient care task to be performed and the display of at least one portion of a patient record relating to the same patient.

2. The system of claim 1 where the display is arranged in a hierarchy prioritized by urgency of patient care tasks.

3. The system of claim 1 where the patient care tasks include approved patient treatment protocols.

4. The system of claim 1 where the system also enables the update of the display to show a history of patient care task completion.

5. The system of claim 1 further related to a third database of resources required to complete the patient care tasks and the inference engine integrates those resources and enables the display of said resources along with the patient care tasks displayed.

6. The system of claim 5 where the resource data includes patient care task consumables or facility assets necessary to complete patient care tasks and the resource data is displayed along with the patient care task data.

7. The system of claim 2 where the hierarchy is arranged using a layout which enables selections of patients or tasks by a skilled caregiver responsible to complete one or more patient care tasks.

8. The system of claim 2 where the hierarchy is presented as selectable display objects associated with patient care tasks and the selectable objects enable the skilled caregiver to access patient care task detail.

9. The system of claim 5 where the display is augmented by selectable objects associated by the inference engine with information regarding the resources necessary to complete the patient care tasks and the selectable objects enable the skilled caregiver to access details regarding those resources.

10. The system of claim 1 that further includes a provision for a sub-system of the inference engine tasked with authentication of the skilled caregiver accessing the system.

11. The system of claim 10 where the display is automatically reconfigured to those patient care tasks performable by the skilled caregiver presently accessing the system.

12. A method of interactive patient care management comprising: creating an inference engine capable of integrating selections from one or more related electronic databases containing patient records and skilled caregiver tasks; integrating the selections from said databases to enable the display of patient care task data and patient record data relevant to the performance of at least one patient care task to a caregiver responsible for patient care.

13. The method of claim 12 where the display method includes hierarchical ordering of patient care tasks prioritized by urgency of patient care.

14. The method of claim 12 where the patient care database includes approved patient care protocols performable by at least one caregiver qualification level.

15. The method of claim 12 where the displayed patient care tasks are further associated by the inference engine with a third related electronic database containing data on resources required to complete the patient care tasks, and the resource data is displayed along with the patient care tasks.

16. The method of claim 15 where the resources include task consumables and facility assets necessary to complete the patient tasks.

17. The method of claim 13 where the display is configured to enable caregiver access to completed task history information.

18. The method of claim 14 where upon selection of a caregiver qualification level from among those presented, the display is reconfigured to those patient care tasks that are performable by the selected caregiver qualification level.

19. The method of claim 12 that that further includes a provision for authentication of the skilled personnel when those personnel access the system and the display is automatically reconfigured to present patient care tasks performable by personnel of their qualifications.

20. A computer readable medium containing instructions necessary to perform a method comprising: creating an inference engine capable of integrating selections from one or more related electronic databases containing patient records, skilled caregiver tasks and resources associated with the tasks and integrating the selections from said databases to enable the display of patient care task data, patient record data, and facility resource data relevant to the performance of at least one patient care task, where the display is arranged in a hierarchical manner relevant to the patient at hand.
